(19) United States
(12) Patent Application Publication
(10) Pub. No.: US 2024/0300843 A1
(43) Pub. Date: Sep. 12, 2024

(54) DRIVE SYNCHRONIZATION FOR SOOT DEPOSITION MACHINE TO PREVENT STRUCTURAL FORMATIONS DURING DEPOSITION PROCESSES

(71) Applicant: Heraeus Quarzglas GmbH & Co. KG, Hanau (DE)

(72) Inventors: Andreas WÄLTE, Bitterfeld-Wolfen (DE); Klaus-Uwe BADEKE, Bitterfeld-Wolfen (DE)

(21) Appl. No.: 18/593,441

(22) Filed: Mar. 1, 2024

(30) Foreign Application Priority Data
Mar. 7, 2023 (EP) 23160463.8

(51) Int. Cl. C03B 37/014

(52) U.S. Cl. CPC C03B 37/0142; C03B 2201/02; C03B 2207/42; C03B 2207/50; C03B 2207/66; C03B 2207/70

(57) ABSTRACT

A method for depositing SiO2 soot particles on a deposition surface using at least two mutually spaced and adjacent build-up burners, and a corresponding device for carrying out the method.

### CROSS-REFERENCE TO RELATED APPLICATIONS

This application claims priority pursuant to 35 U.S.C. 119 (a) to European Application No. 23160463.8, filed Mar. 7, 2023, which application is incorporated herein by reference in its entirety.

### FIELD

The present invention relates to a method and device for producing synthetic quartz glass in which structural formations are substantially prevented during deposition processes.

### BACKGROUND

Numerous methods for producing synthetic quartz glass are known from the prior art, wherein SiO₂ soot particles are generated from a silicon-containing starting substance in a CVD method by hydrolysis or oxidation and are deposited on a moving carrier. In these methods, a plurality of adjacent build-up burners are sometimes used in which SiO₂ soot particles are produced.

U.S. Pat. No. 5,211,732 describes a soot build-up method for producing synthetic quartz glass in which unequal deposition rates of adjacent build-up burners and longer dwell times of the build-up burners at the corresponding reversal point during each reciprocating movement are smeared according to a fixed pattern by varying the final travel positions (inflection points) of the build-up burners. The oscillatory movement is superimposed by an additional displacement movement, wherein, according to FIG. 7 of U.S. Pat. No. 5,211,732, the oscillation and the displacement movement can have an amplitude identical to the burner-to-burner distance. The translation amplitude is approximately half of the oscillation amplitude. The frequency of the translational movement, in turn, corresponds approximately to one-tenth of the oscillation frequency. This results in a substantially uniform overlap of all regions of the target by two adjacent build-up burners in the axial direction and by three adjacent burners in the region of the translation reversal points (inflection points). In this prior art, however, there is no correlation between oscillation frequency and rotational frequency. Thus, unfavorable frequency ratios cannot be ruled out and occur regularly.

US 2018/0237330 A describes an OVD soot build-up method for producing porous preforms for optical fibers. In this case, the focus is on avoiding core eccentricities that can occur due to an uneven deposition thickness during soot build-up, in particular in the case of large preforms. For this purpose, different specifications are made at different phases of the soot build-up to prevent burner traces from coinciding. In this case, the device can have one or more soot build-up burners. The prevention of burner traces coinciding according to this prior art is also described for other methods of quartz glass production, for example for an MCVD method or a PCVD method. In the method described, the quartz glass body is rotated during the build-up process and the burners describe a reversing movement, wherein burner traces then coincide when the times that the body requires for a rotation and the burners require for a reversing movement are in such a ratio to one another that the starting point for the reversing burner movement is identical after one or more runs. In addition, the prior art teaches that this state of coinciding burner traces is to be avoided, in particular in the case of high layer thicknesses, whereas it can be quite positive at low layer thicknesses. In order to prevent burner traces from coinciding with one another at high layer thicknesses, specifications are defined for the angle of movement, wherein the angle of movement describes a line from the body axis up to a fixed point on the soot body surface for the duration of a reversing burner movement. Thus, this prior art considers the adjustment of a single burner and thus the adjustment of the position of a single burner trace.

EP 3 279 155 A relates to a method for building up a soot body that is deposited on a carrier body. The carrier body reciprocates relative to a build-up burner and thus performs a reversing movement. When the body radius is in a range of 50 to 80% of the target radius, the rotational speed r and the burner translation speed V are gradually reduced such that the trace width V/r remains substantially constant and does not change by more than 10%. This measure is intended to reduce the variation in the diameter of the soot body.

JP 2013/043810 A describes a build-up method for a soot body in which wave formation in the soot body is suppressed in order to achieve improved transmission of an optical fiber produced from the soot body. The soot body is rotated during the build-up process and the build-up burner is reciprocated in a reversing movement relative thereto. The wave formation is achieved by synchronizing the rotational movement with the translational movement, wherein a cycle of the reciprocating movement is completed while the body has been rotated (n+½) times, where n=0, 1, 2, . . . . An offset of adjacent layers of one and the same burner is thereby achieved. However, the prior art does not describe how the rotation of the soot body and the translation of the burners are to be synchronized so that the traces from the adjacent burner of a burner assembly do not interfere.

U.S. Pat. Nos. 6,678,940; 7,451,623; 7,541,624; US 2009/0038346 A; and U.S. Pat. No. 8,635,888 describe methods for building up soot bodies in which a random variation of the rotational speed is used in order to avoid waviness.

US 2002/081377 A describes a multi-burner assembly in which the layers of spirals of the burner traces are intentionally set relative to one another. The method is carried out in such a way that successive burner traces are spaced apart.

JP H0725637 A describes an OVD soot build-up method, wherein a constant variation of the trace width is carried out. In the exemplary embodiments, this variation is achieved by varying either the burner speed or the rotation of the soot body in small regions.

JP H0687624 A describes an OVD soot build-up method that avoids waviness of the soot body surface. For this purpose, the build-up burner performs a reversing movement relative to the build-up target and thereby generates a soot spiral. On the return path of the build-up burner, the target is rotated in the opposite direction and the soot trace is placed so that it is produced precisely between the trace of the forward path.

WO 02/057193 A2 describes a method for producing an SiO₂ blank, in which SiO₂ particles are formed in a plurality of deposition burners arranged in series and deposited on a deposition surface of a carrier rotating about its longitudinal axis. The series of deposition burners moves back and forth according to a predetermined movement sequence along the blank being formed, and between inflection points at which the movement direction is reversed.

JP 2003/081045 A describes a method for producing glass particles that by relatively traversing a rotating starting rod and a burner and by successively depositing the glass particles synthesized by this burner on the surface of the starting rod, wherein the rotational speed and the movement speed of the starting rod can be changed.

### Object

Based on this prior art, it is the object of the present invention to provide a method for depositing SiO₂ soot particles on a deposition surface using at least two mutually spaced build-up burners, in which the oscillation frequency of the deposition burner, the rotation frequency of the soot body and optionally the position of the inflection points are changed continuously such that a homogeneous deposition of the SiO₂ soot particles is achieved with good deposition efficiency.

The method according to the invention is intended in particular to be suitable for preventing unfavorable movement patterns in which a repeated deposition of the SiO₂ soot particles occurs over a plurality of rotations of the soot body at the same or closely adjacent axial positions in the same angular plane, i.e., in the plane consisting of the longitudinal axis of the soot body and an arbitrary point on its jacket surface.

### Method for Deposition of SiO₂ Soot Particles

These objects are achieved by a method for depositing SiO₂ soot particles on a deposition surface using at least two mutually spaced build-up burners, wherein on the one hand a special correlation of the oscillation and rotational frequencies is selected, and on the other hand the underlying technical effect is achieved by a positional displacement of the reversal points during the translational movement of the build-up burners. In this context, the oscillation frequency means the frequency of the translation of the build-up burners with respect to the longitudinal axis of the soot body formed, either by movement of the build-up burners, by movement of the soot body, or by simultaneous movement of the build-up burners and the soot body, and the rotational frequency means the frequency of the rotation of the soot body about its longitudinal axis.

The present invention thus provides a method for depositing SiO₂ soot particles on a deposition surface using at least two mutually spaced and adjacent build-up burners, wherein the distance between the at least two build-up burners is d; and the deposition surface is a cylinder jacket surface of a carrier rotating about its longitudinal axis, on which carrier SiO₂ soot particles are deposited layer by layer.

The method according to the invention is then characterized in that the build-up burners perform a translational movement relative to the deposition surface, substantially parallel to the longitudinal axis of the rotating carrier, by an amplitude of the n-fold burner-to-burner distance d, wherein n is an integer greater than or equal to 2 and d corresponds to the single burner-to-burner distance, the deposition surface rotates m₁ times about the longitudinal axis of the carrier, wherein m₁ is a positive decimal number other than an integer, and the period of time for the m₁-times rotation of the longitudinal axis of the carrier substantially corresponds to the period of time for the translational movement of the build-up burners from a burner-to-burner distance d.

Within the scope of the present invention, the position of adjacent traces of the build-up burners is thus adjusted by adjusting the ratio of the rotational frequencies of the soot body and the translation of the build-up burners with respect to the longitudinal axis of the soot body. According to the invention, it is accordingly specified that the soot body performs a number of rotations that is not an integer (m₁ is a decimal number that is not an integer) while a burner performs a translation from a single burner-to-burner distance in one stroke.

In the method according to the invention, each build-up burner, during its translational movement with simultaneous rotation of the SiO₂ soot body, deposits a spiral trace on the soot body, and by the above-described ratio of rotation and translation, the traces of the build-up burners are placed so as to form a homogeneous soot body. In the context of the present invention, a homogeneous soot body is understood to mean, in particular, a soot body having a homogeneous density, for example due to the homogeneous trace layers obtained.

Before the method according to the invention is described in detail, a few definitions for the method according to the invention should first be given.

### Definitions

Within the scope of the present invention, a “reversing movement” of the build-up burners is understood to mean when the build-up burners move in one or the other direction parallel to the longitudinal axis of the rotating carrier during a temporally coordinated change.

Within the scope of the present invention, a build-up burner is understood to mean burner in which SiO₂ soot particles are produced and deposited from a cylinder onto a deposition surface. When in the context of the present invention reference is made to a build-up burner in the singular, the use of the singular does not necessarily mean that only one build-up burner is used. Likewise, the singular “build-up burner” can be used for two or more build-up burners.

Within the scope of the present invention, an “inflection point” is understood to mean a spatial point of the longitudinal axis or an axial position on the longitudinal axis of the rotating carrier at which the direction of the reversing movement of the build-up burners and/or the deposition surface changes.

Within the scope of the present invention, a “stroke” is understood to mean the complete movement of the build-up burners and/or of the deposition surface in a direction of the reversing movement up to an inflection point at which the movement of the build-up burners and/or the deposition surface reverses.

Within the scope of the present invention, an “amplitude of translation” means
a) the absolute path of movement of a build-up burner in a direction along the static longitudinal axis of the rotating carrier up to an inflection point of the reversing movement,
b) the absolute path of movement of the deposition surface along a statically fixed build-up burner up to an inflection point of the reversing movement or
c) the absolute sum of the path of movement of a build-up burner up to an inflection point of the reversing movement of the build-up burner and the path of movement of the deposition surface up to an inflection point of the reversing movement of the deposition surface when the build-up burners and the deposition surface move in opposite directions.

In the context of the present invention, at least two build-up burners are used. These at least two build-up burners have a distance from one another that is substantially parallel to the longitudinal axis of the soot body of d. It is of course possible for more than two build-up burners to be used in the method according to the invention. In this embodiment, the distance of adjacent build-up burners is in each case d; this means that the build-up burners are arranged equidistant from one another. In the method according to the invention, at least 2, preferably 10 to 100, even more preferably 20 to 50 build-up burners are used. In the context of the present invention, the entirety of the build-up burners arranged equidistant from one another is referred to as a burner assembly.

### PREFERRED EMBODIMENTS

The method according to the invention is preferably carried out as an OVD method. In the OVD method according to the invention, a layer structure having a spiral layer running substantially concentrically with respect to the longitudinal axis of the blank is preferably produced by depositing SiO₂ particles layer by layer on the cylinder jacket surface of the carrier rotating about its longitudinal axis, while the build-up burner performs a translational movement parallel to the longitudinal axis of the cylinder jacket surface. In contrast, the VAD method, which is also possible according to the invention, in which a massive SiO₂ cylinder is built up by axial deposition in the direction of the longitudinal axis of the cylinder on a disk-shaped rotating carrier, usually results in a spiral layer structure with axially successive layers that extend perpendicularly to the longitudinal axis of the cylinder.

In the context of OVD methods, different method designs are possible according to the invention.

In a first embodiment, the OVD method is carried out with a soot hollow cylinder on which the SiO₂ soot particles are deposited. In this case, the hollow cylinder is held in a vertical or horizontal orientation, preferably in a horizontal orientation, by means of a holding device. A horizontal arrangement is preferred in particular in the production of relatively heavy SiO₂ soot bodies. The corresponding SiO₂ soot particles are then deposited on the hollow cylinder. The SiO₂ soot body, which is in the form of a hollow cylinder, can have a carrier in its interior, on which the first SiO₂ soot particles are deposited at the beginning of the method according to the invention. For this purpose, a ceramic carrier can be used, for example, which is removed after the soot build-up process, after which the soot body is further processed and finally vitrified.

In addition, the method according to the invention can be carried out as a so-called SOCR method (SOCR=soot on core rod) in which the SiO₂ soot particles produced are deposited directly on a core rod, which is generally made of quartz glass. The core rod can then remain in the OVD body. Corresponding process products that can be produced using an SOCR method are preforms made from core rods with soot layers.

A further embodiment of the method according to the invention is the so-called AVAD method (advanced VAD method), in which a VAD soot body is first produced. Subsequently, by means of an OVD method, SiO₂ soot particles are deposited on the outside of the not-yet-vitrified VAD soot body.

In the prior art, the formation of layer structures is inherent in the aforementioned production method due to the layer-by-layer deposition of SiO₂ particles. These can become noticeable as what are known as striae, which indicate refractive index differences between adjacent layers.

By adjusting the movement patterns according to the invention, these and the above-mentioned disadvantages of the layer structures can be efficiently avoided.

In a preferred embodiment of the method according to the invention, the deposition surface rotates about the longitudinal axis of the carrier.

In a further preferred embodiment, the period of time for the (m₂+(k/n))-times rotation of the deposition surface about the longitudinal axis of the carrier substantially corresponds to the period of time for the translational movement of the build-up burners from a burner-to-burner distance d, wherein m₂ is an integer from 1 to 100, preferably from 3 to 35, even more preferably from 5 to 25, even more preferably from 6 to 24, even more preferably from 7 to 23, even more preferably from 8 to 22, even more preferably from 9 to 21, even more preferably from 10 to 20, even more preferably from 10 to 20. Particularly preferably, m₂ is an integer less than 25, more preferably m₂ is an integer less than 15. k is a natural number less than n and m₁ is equal to m₁=m₂+(k/n). The variable n, which determines the total amount of translation in one direction and thus the amplitude, is preferably an integer greater than or equal to 2, more preferably an integer greater than or equal to 2 and less than or equal to 10, even more preferably an integer greater than or equal to 2 and less than or equal to 5, even more preferably 2, 3 or 4, in particular 2.

In a particularly preferred embodiment, the period of time for the (m2+(k/n))-times rotation of the deposition surface about the longitudinal axis of the carrier substantially corresponds to the period of time for the translational movement of the build-up burners from a burner-to-burner distance d, wherein m₂ is equal to an integer from 5 to 25, preferably less than 15, k is a natural number less than n, and m₁=m₂+(k/n), and wherein the variable n, which determines the total amount of translation in one direction and thus the amplitude, is an integer greater than or equal to 2.

According to the invention, m₂ is equal to the number of rotations while the burners make a translation of one burner-to-burner distance. This means that as m₂ increases, the pitch decreases. According to the invention, “pitch” means the distance the soot body winds in the direction of the cylinder axis during a full revolution. At high values of m₂, the burner traces are thus partially located on the traces from the previous rotation, i.e., the traces overlap heavily. As a result, the trace is applied to a highly preheated substrate on one side, while the other side is relatively cool. It has been observed that increased bubble formation (spiral elongated bubbles) can take place in the vitrified body in the case of heavily overlapping burner traces.

An advantage according to the invention of an amplitude of the translation by then-fold burner-to-burner distance is that the produced soot body made of SiO₂has conical ends resulting therefrom. These conical ends can be solidified using additional heating burners and additional heaters. Analogous to the build-up burners, the additional heating burners perform a translation together with the build-up burners during the movement of the build-up burners, while the additional heaters have a stationary position relative to the soot body.

A further advantage of an amplitude by the n-fold burner-to-burner distance is that in each region of the SiO₂ soot body, more than one burner builds up the soot body, so that any geometry variations due to deviating build-up rates of individual build-up burners do not have as great an effect.

In the multi-burner method according to the invention, the burners have an equidistant arrangement and are moved together along the longitudinal axis of the soot body. In this case, each burner builds up the soot body only in a limited region of the soot body, because the amplitude in one stroke is significantly smaller than the length of the soot body to be built up.

Assuming the use of at least two build-up burners, a reference build-up burner and a second build-up burner adjacent thereto, the uneven rotation of the soot body in the second translation by the burner-to-burner distance d results in a spiral deposition trace of the second build-up burner between the first deposition trace (formed during the first translation by the single burner-to-burner distance d) and the second deposition trace (formed during the second translation by the simple burner-to-burner distance d) of the reference build-up burner.

This ensures that after the individual translations, the deposition traces of the reference build-up burner and of the adjacent second build-up burner do not overlap.

In the above-described preferred embodiment of the method according to the invention, in which the build-up burners perform a translational movement substantially parallel to the longitudinal axis of the rotating carrier by an amplitude of the n-fold burner-to-burner distance d, while in a period of time in which the translation proceeds by the single burner-to-burner distance, the deposition surface rotates by a number of (m₂+(k/n)) about its longitudinal axis and m₂ is equal to an integer from 1 to 100, preferably from 3 to 35, even more preferably from 5 to 25, even more preferably from 6 to 24, even more preferably from 7 to 23, even more preferably from 8 to 22, even more preferably from 9 to 21, even more preferably from 10 to 20, even more preferably from 10 to 20. Particularly preferably, m₂ is an integer less than 25, more preferably m₂ is an integer less than 15. k is a natural number less than n and m₁, which is equal to m₁=m₂+(k/n), the deposition trace of the second build-up burner is arranged exactly midway between the two deposition traces of the reference build-up burner.

In the above-described preferred embodiment of the method according to the invention, in which the build-up burners perform a translational movement substantially parallel to the longitudinal axis of the rotating carrier by an amplitude of the n-fold burner-to-burner distance d, while in a period of time in which the translation proceeds by the single burner-to-burner distance, the deposition surface rotates by a number of (m₂+(k/n)) about its longitudinal axis and m₂ is equal to an integer from 5 to 25, preferably less than 15, k is a natural number less than n, and m₁=m₂+(k/n), the deposition trace of the second build-up burner is arranged exactly midway between the two deposition traces of the reference build-up burner.

If the device according to the invention comprises more than two build-up burners, an interference, i.e., a superposition, of all deposition traces of the build-up burners used is efficiently avoided by the substantially equidistant distance between the respective build-up burners.

In the method according to the invention, a device is used in which the distance of adjacent build-up burners is generally equidistant and in which the distance between two adjacent build-up burners is preferably 10 to 300 mm, more preferably 30 to 300 mm, even more preferably 15 to 150 mm.

In the present invention, the translational movements of the build-up burners represent a reversing movement, the direction of which, in each case parallel to the longitudinal axis of the soot body, changes at inflection points. In order that, after a forward movement of the build-up burners (first complete stroke) and a return movement (second complete stroke) of the build-up burners, in each case substantially parallel to the longitudinal axis of the soot body, there is no superimposition of the starting points of the burners during the next forward movement (third complete stroke) of the build-up burners, it is provided in a further embodiment of the method according to the invention that the position of the inflection points changes relative to the deposition surface. Furthermore, if the deposition traces of the reciprocating movement are considered, points of intersection are obtained at which a clustered deposition takes place. A goal in determining the movement pattern is that these points of intersection are evenly distributed over the soot body.

The variation of the translation by changing the inflection points can take place in each stroke of the reversing movement. Furthermore, it is possible for the variation of the translation to take place by changing the inflection points in each second, third, fourth or fifth stroke of the reversing movement.

In a first embodiment, the position of the inflection points can be changed by a fixedly defined offset in the corresponding stroke in which a change in the inflection points is to be carried out (i.e., the inflection points change in each stroke according to a fixedly predefined movement pattern).

Alternatively, it is also possible that the position of the inflection points in the respective stroke in which a change in the inflection points is to be carried out is changed by a statistically changed offset in each corresponding stroke. In this embodiment, the change in position of the inflection points varies statistically (i.e., the inflection points change by a statistically changed offset in each stroke).

In both embodiments, the offset is then determined with respect to a reference inflection point.

In principle, two procedures are possible for the specific change of the inflection points.

In a first procedure, after a complete rotation before the fixed reference inflection point, a partial rotation multiplied by a random number between 0 and 1 is added, and the position of the reference inflection point is changed by this length. The remaining partial rotation is carried out on the return path. Movement then takes place until the end of the last complete rotation before the next inflection point, where the method is repeated. The offset of the reversal points must be such that the points of incidence of the burners in the following stroke are offset in the 0° plane, wherein a uniform distribution between 0 and 1 also allows no offset (e.g. in the first stroke for 0 and 1). The numerical values change in the following strokes, which depends on the length of the corresponding previous stroke or its inflection point positions.

Due to the variation of the inflection points according to the invention, it is possible to control the position of the burner traces without having to intervene in the rotational speed. This is particularly advantageous because the rotational speed strongly affects the density of the soot.

According to U.S. Pat. No. 5,211,732 A, the displacement amplitude of the burner inflection 10 points is approximately one burner-to-burner distance. The position of the burner inflection points is thus distributed over the entire soot body, and the length of the conical end caps is thereby determined. In contrast, according to the present invention, the distribution of the burner inflection points over the entire soot body is dispensed with, wherein the length of the end caps is generated by the amplitude of the double burner-to-burner distance 2d.

In a second procedure, the position of each inflection point is changed such that the first deposition point of a build-up burner is always located at a specific location on the return path with respect to the fixed reference inflection point. This position is determined by the addition of a partial rotation with respect to the reference inflection point multiplied by a random number between −0.5 and +0.5.

A combination of the measures described above for avoiding interferences can also be carried out in such a way that the build-up burners perform a translational movement substantially parallel to the longitudinal axis of the rotating carrier by an amplitude of twice the burner-to-burner distance 2d, while the deposition surface substantially simultaneously performs a rotation of (m₂+(k/n)+y) revolutions, wherein m₂ is an integer from 1 to 100, preferably from 3 to 35, even more preferably from 5 to 25, even more preferably from 6 to 24, even more preferably from 7 to 23, even more preferably from 8 to 22, even more preferably from 9 to 21, even more preferably from 10 to 20, even more preferably from 10 to 20. Particularly preferably, m₂ is an integer less than 25, more preferably m₂ is an integer less than 15. k is a natural number less than n, m₁ is equal to m₁=m₂+(k/n) and y is between −0.3 and 0.3 and can change continuously in the method according to the invention.

A combination of the measures described above for avoiding interferences can also be carried out in such a way that the build-up burners perform a translational movement substantially parallel to the longitudinal axis of the rotating carrier by an amplitude of twice the burner-to-burner distance 2d, while the deposition surface substantially simultaneously performs a rotation of (m₂+(k/n)+y) revolutions, wherein m₂ is an integer from 5 to 25, preferably less than 15, k is a natural number less than n, m₁=m₂+(k/n) and y is between −0.3 and 0.3 and can change continuously in the method according to the invention.

In this embodiment of the method according to the invention, the variation of the position of the inflection points can then be dispensed with. As a result, in a first variant of this embodiment, the position of the inflection points is fixedly defined, whereas in a second variant of this embodiment the position of the inflection points can vary.

If in this embodiment of the method according to the invention a variation of the position of the inflection points takes place, the positions of the inflection points can change in each stroke of the reversing movement. Alternatively, it is possible for the position of the inflection points to change by a fixedly defined offset in each stroke.

The variable y described above, which is between −0.3 and 0.3 and can change continuously in the method according to the invention, can be changed in the course of the method according to the invention either according to a fixed pattern, a statistical distribution or in a controlled manner, wherein the controlled mode of operation can serve to optimize the uniform soot application.

If the position of the inflection points changes, it should be noted that the inflection points are in each case changed such that the amplitude is on average equal to the n-fold burner-to-burner distance, otherwise diameter fluctuations will occur in the soot body. The inflection points can be changed by a statistically changed offset in each stroke. For the present invention, it is crucial that the overall method conditions, i.e., the rotation of the deposition surface and the variation of the inflection points, are carried out by a person skilled in the art in such a way that the method as a whole results in a homogeneous soot structure.

It is preferred if the movement profile of the build-up burners on the deposition surface is determined. In order to ensure a homogeneous soot structure, the movement profile of the build-up burners on the deposition surface is preferably continuously monitored during the deposition of the SiO₂ soot particles.

In particular, it is preferred if the movement profile of the build-up burners on the deposition surface is continuously monitored online by means of a processor during the deposition of the SiO₂ soot particles.

Furthermore, it is preferred if the device according to the invention comprises a processor that is designed to identify, from the movement profile of the build-up burners on the deposition surface, regions of the deposition surface in which too few SiO₂ soot particles have been deposited for a homogeneous soot build-up.

In such a case, the processor preferably controls the rotation of the deposition surface about the longitudinal axis of the carrier and/or the position of the inflection points of the reversing translational movement of the build-up burners such that a substantially homogeneous soot body is built up.

In the method according to the invention, the longitudinal axis of the rotating carrier can be oriented vertically or horizontally; the build-up burners are arranged accordingly. It is preferred that the longitudinal axis of the rotating carrier be oriented horizontally.

Because the soot body is built up layer by layer in the method according to the invention, the frequencies of the translation of the build-up burners and the rotation of the deposition surface during each change of direction of the reversing movement of the build-up burners are adapted to the current diameter of the SiO₂ soot body.

In the context of the present invention, the spatial arrangement of the build-up burners relative to one another is generally rigid and the translational movement relative to the carrier is generally performed together.

For the deposition of the SiO₂ soot particles, at least 2 build-up burners, preferably 10 to 100 build-up burners, more preferably 20 to 50 build-up burners are usually used, wherein the distance between the respective build-up burners is substantially constant and is equal to d.

Furthermore, the frequencies of the translation of the build-up burners and the rotation of the deposition surface during each change of direction of the reversing movement of the build-up burners are usually adapted to the current diameter of the SiO₂ soot body.

The method according to the invention preferably comprises the following method steps:
(1) evaporating a feedstock material containing at least one organosilicon starting compound to form a feedstock material vapor;
(2) feeding the feedstock material vapor from method step (1) to a reaction zone in which the feedstock material vapor is combusted in the presence of oxygen in a flame and converted to SiO₂ soot particles by oxidation and/or hydrolysis;
(3) depositing the SiO₂ soot particles resulting from method step (2) on a deposition surface to form a soot body;
(4) drying and vitrifying the soot body resulting from method step (3) to form synthetic quartz glass.

The individual method steps are described in more detail below:

### Method Step (1)—Evaporation of the Feedstock Material

In method step (1), a feedstock material containing at least one organosilicon starting compound is evaporated to form a feedstock material vapor. The polymerizable silicon-containing starting compound is preferably a polymerizable polyalkylsiloxane compound.

In principle, any polymerizable polyalkylsiloxane compound that is suitable for the production of synthetic quartz glass can be used according to the invention. Within the scope of the invention, the term “polyalkylsiloxane” includes both linear (also including branched structures) and cyclic molecular structures.

Particularly suitable cyclic representatives are polyalkylsiloxanes having the general empirical formula:

SiₚOₚ(R)₂ₚ,

wherein p is an integer greater than or equal to 3. The radical “R” is an alkyl group, in the simplest case a methyl group.

Polyalkylsiloxanes are characterized by a particularly high proportion of silicon per weight percentage, which makes their use in the production of synthetic quartz glass economical.

The polyalkylsiloxane compound is preferably selected from the group consisting of hexamethylcyclotrisiloxane (D3), octamethylcyclotetrasiloxane (D4), decamethylcyclopentasiloxane (D5), dodecamethylcyclohexasiloxane (D6), tetradecamethylcycloheptasiloxane (D7), hexadecamethylcyclooctasiloxane (D8) as well as linear homologues thereof and any mixtures of the aforementioned compounds. The notation D3, D4, D6, D7 and D8 comes from a notation introduced by General Electric Inc. where “D” stands for the group [(CH₃)₂Si]—O—.

In the context of the present invention, mixtures of the aforementioned polyalkylsiloxane compounds can also be used.

Octamethylcyclotetrasiloxane (OMCTS) is currently preferred due to its wide availability in high purity. In the context of the present invention, it is therefore particularly preferred if the polyalkylsiloxane compound is octamethylcyclotetrasiloxane (D4).

In principle, it is possible for the feedstock material to be subjected to purification prior to introduction into method step (1). Such purification methods are known to a person skilled in the art. In a preferred embodiment, however, the feedstock material is not previously subjected to an upstream purification method.

Evaporation of the feedstock material can take place with or without the presence of a carrier gas component. Evaporation of the feedstock is preferably carried out in the presence of a carrier gas, because this allows evaporation to take place at temperatures below the boiling point of the organosilicon starting compound. An inert gas, for example nitrogen or argon, is usually used as the carrier gas. If a carrier gas is used, the molar ratio of the organosilicon starting compound to the carrier gas is preferably in the range from 0.01 to 2; particularly preferably in the range from 0.02 to 1.5 and very particularly preferably in the range from 0.05 to 1.25. In particular, it is preferred that nitrogen with a moisture content of <40 ppm by volume be used as the carrier gas and that OMCTS be used as the organosilicon starting compound. It is furthermore preferred that the molecular ratio of OMCTS to nitrogen is in the range from 0.015 to 1.5.

The method step of evaporation is known per se to a person skilled in the art. The organosilicon starting compound is preferably converted to a vapor phase at temperatures between 120 and 200° C., depending on the selected molecular ratio of the organosilicon starting compound and carrier gas. The evaporation temperature in the evaporation chamber should always be at least a few degrees above the dew point of the organosilicon starting compound. The dew point, in turn, depends on the selected molecular ratio of the organosilicon starting compound to the carrier gas. In a preferred embodiment method, for this purpose, the organosilicon starting compound is preheated to temperatures between 40 and 120° C. prior to evaporation and then sprayed into an evaporation chamber that has a higher temperature than the preheating of the starting materials. In a preferred embodiment, the inert carrier gas can additionally be preheated to temperatures of up to 250° C. before being fed to the evaporation chamber. It is advantageous that the temperature in the evaporation chamber is always above the dew point temperature of the mixture of organosilicon starting compound and carrier gas. Suitable evaporation methods are described, for example, in the international patent applications WO 2013/087751 A and WO 2014/187513 A and the German patent application DE 10 2013 209 673.

Within the scope of the invention, the term “dew point” describes the temperature at which a state of equilibrium is established between condensing and evaporating liquid.

Within the scope of the present invention, “evaporation” is understood to mean the process by which the feedstock material is substantially transferred from the liquid phase to a gaseous phase. This is preferably done by using temperatures that are above the dew point of the organosilicon starting compound as the main component of the feedstock material, as described above. The person skilled in the art will be aware that, from a process technology point of view, it cannot be excluded that small liquid droplets of the feedstock material may be entrained. Thus, in method step (1), a feedstock material vapor is preferably produced that preferably contains not less than 97 mol. %, preferably not less than 98 mol. %, particularly preferably not less than 99 mol. %, very particularly preferably not less than 99.9 mol. % of gaseous components.

The vaporous organosilicon starting compound, or a mixture of carrier gas and vaporous organosilicon starting compound, is usually removed from the evaporation chamber and fed to the build-up burners. Before being introduced into the build-up burners, the vaporous material or the mixture of vaporous material and carrier gas is preferably mixed with oxygen. In the flame, the organosilicon starting compound is oxidized to SiO₂. A fine-particle amorphous SiO₂ (SiO₂ carbon black) is formed, which is first deposited in the form of a porous mass on the surface of a carrier and later on the surface of the soot body being formed.

### Method Step (2)—Feeding the Feedstock Material Vapor to a Reaction Zone in Which the Feedstock Material Vapor is Combusted in the Presence of Oxygen in a Flame and Converted to SiO₂ Soot Particles by Oxidation and/or by Hydrolysis

In method step (2), the gaseous feedstock material vapor resulting from method step (1) is fed to a reaction zone in which the feedstock material vapor is converted to SiO₂ particles by oxidation and/or by hydrolysis.

This method step corresponds to the known soot method already described in more detail above.

Concentric build-up burners, which have gas outlet nozzles arranged in a circle around the corresponding center point of the burner mouth, are usually used for the combustion of the feedstock material vapor.

Within the scope of the present invention, a procedure is preferred in which the build-up burners are supplied with a first silicon-containing starting component in a central region, an oxygen stream in an outer region, and a barrier gas stream (hydrogen) between the central region and the outer region.

The central nozzle is generally used to supply the feedstock material vapor, which within the scope of the present invention is usually used in premixed form with a carrier gas. In addition, oxygen is preferably added to the feedstock material vapor, so that a feed stream results from the central nozzle of the usually used concentric build-up burners, which feed stream contains the carrier gas and oxygen in addition to the feedstock material vapor.

The central nozzle of the build-up burners is usually comprised by a second nozzle, which is arranged concentrically around the central nozzle, and from which a barrier gas is introduced into the burner. This barrier gas separates the SiO₂ starting compound from the rest of the oxygen stream, which flows into the burner from a further concentric nozzle arranged concentrically around the central nozzle and the barrier gas nozzle.

The SiO₂ soot particles produced by means of the build-up burners are usually deposited on a carrier tube rotating about its longitudinal axis, so that the soot body is built up layer by layer. For this purpose, they are reciprocated between two inflection points along the longitudinal axis of the carrier tube. The embodiment of this translation was described in more detail above.

The build-up burners, at least two of which are used within the scope of the present invention, constitute a burner block.

### Method Step (3)—Deposition of the SiO₂ Particles

In method step (3), the SiO₂ particles resulting from method step (2) are deposited on a deposition surface. The design of this method step is within the skill and knowledge of a person skilled in the art.

For this purpose, the SiO₂ particles formed in method step (2) are deposited layer by layer on a rotating carrier to form a porous soot body.

During the deposition of the soot particles, the distance between the burner and the carrier material is optionally changed in order to satisfy the above-described condition.

### Method Step (4)—Optional Drying and Vitrification

In method step (4), the SiO₂ particles resulting from process step (3) are dried and vitrified to form synthetic quartz glass. This method step is necessary because the previously carried out method steps were carried out according to a soot method. The design of this method step is within the skill and knowledge of a person skilled in the art.

The method according to the invention is carried out as a “soot method” in which the temperature during the deposition of the SiO₂ particles in method step (3) is so low that a porous SiO₂ soot layer is obtained that is dried and vitrified in the separate method step (4) to form synthetic quartz glass.

The above disadvantages of the prior art can be efficiently avoided by the method according to the invention.

### Device for Deposition of SiO₂ Soot Particles

In a further aspect, the present invention relates to a device for carrying out the method according to the invention described above. The device according to the invention is used to deposit SiO₂ soot particles on a deposition surface and has at least two mutually spaced build-up burners, wherein
the distance between the at least two build-up burners is d; and
the deposition surface is a cylinder jacket surface of a carrier rotating about its longitudinal axis, on which carrier SiO₂ soot particles are deposited layer by layer.

The device according to the invention is then characterized in that
the build-up burners and the deposition surface are configured such that the build-up burners perform a translational movement relative to the deposition surface, substantially parallel to the longitudinal axis of the rotating carrier, by an amplitude of the n-fold burner-to-burner distance d, wherein n is an integer greater than or equal to 2 and d corresponds to the single burner-to-burner distance,
the deposition surface is configured such that the deposition surface rotates m1 times about the longitudinal axis of the carrier, wherein m1 is a positive decimal number other than an integer, and
the device has a controller that is configured such that the period of time for the m1-times rotation of the longitudinal axis of the carrier substantially corresponds to the period of time for the translational movement of the build-up burners from a burner-to-burner distance d.

The controller of the device can be a processor with appropriate programming.

The controller according to the invention is preferably configured such that the build-up burners perform a translational movement substantially parallel to the longitudinal axis of the rotating carrier by an amplitude of the n-fold burner-to-burner distance d, wherein n is an integer greater than or equal to 2 and d corresponds to the single burner-to-burner distance and the deposition surface rotates about the longitudinal axis of the carrier.

By controlling the device according to the invention, it is achieved that the period of time for the (m₂+k/n)-times rotation of the deposition surface about the longitudinal axis of the carrier substantially corresponds to the period of time for the translational movement of the build-up burners from a burner-to-burner distance d, wherein m₂ is an integer from 1 to 100, preferably from 3 to 35, even more preferably from 5 to 25, even more preferably from 6 to 24, even more preferably from 7 to 23, even more preferably from 8 to 22, even more preferably from 9 to 21, even more preferably from 10 to 20, even more preferably from 10 to 20. Particularly preferably, m₂ is an integer less than 25, more preferably m₂ is an integer less than 15, wherein k and n are as defined above.

By means of the controller of the device according to the invention, it is achieved that the period of time for the (m₂+k/n)-times rotation of the deposition surface about the longitudinal axis of the carrier substantially corresponds to the period of time for the translational movement of the build-up burners from a burner-to-burner distance d, wherein m₂ is an integer from 5 to 25, preferably less than 15, and k and n are as defined above.

The device according to the invention is configured such that it allows the translational movements of the build-up burners to represent a reversing movement whose direction changes at inflection points, wherein the position of the inflection points can change relative to the deposition surface. The change of the inflection points is also carried out by the controller of the device according to the invention.

The controller of the device is further configured such that the inflection points of the reversing movement can change in each stroke, wherein the controller can allow the inflection points to change in each stroke by a fixedly defined offset or allow the inflection points to change in each stroke by a statistically changed offset.

The device according to the invention is configured such that the build-up burners perform a translational movement substantially parallel to the longitudinal axis of the rotating carrier by an amplitude of twice the burner-to-burner distance 2d, while the deposition surface substantially simultaneously performs a rotation of (m₂+k/n+y) revolutions, wherein n is an integer greater than or equal to 2 and y is a number less than 0.3, preferably less than 0.2, more preferably less than 0.15, more preferably less than 0.1, and wherein m₂ is an integer from 1 to 100, preferably from 3 to 35, even more preferably from 5 to 25, even more preferably from 6 to 24, even more preferably from 7 to 23, even more preferably from 8 to 22, even more preferably from 9 to 21, even more preferably from 10 to 20, even more preferably from 10 to 20. Particularly preferably, m₂ is an integer less than 25, more preferably m₂ is an integer less than 15, wherein k and n are as defined above.

The device according to the invention is configured such that the build-up burners perform a translational movement substantially parallel to the longitudinal axis of the rotating carrier by an amplitude of twice the burner-to-burner distance 2d, while the deposition surface substantially simultaneously performs a rotation of (m₂+k/n+y) revolutions, wherein n is an integer greater than or equal to 2 and y is a number less than 0.3, and wherein m₂ is an integer from 5 to 25, preferably less than 15, and k and n are as defined above.

What is claimed is:

1. A method for depositing SiO₂ soot particles on a deposition surface using at least two mutually spaced and adjacent build-up burners, wherein
the distance between the at least two build-up burners is d; and
the deposition surface is a cylinder jacket surface of a carrier rotating about its longitudinal axis, on which carrier SiO₂ soot particles are deposited layer by layer,
wherein
the build-up burners perform a translational movement relative to the deposition surface, substantially parallel to the longitudinal axis of the rotating carrier, by an amplitude of the n-fold burner-to-burner distance d, wherein n is an integer greater than or equal to 2 and d corresponds to the single burner-to-burner distance,
the deposition surface rotates m₁ times about the longitudinal axis of the carrier, wherein m₁ is a positive decimal number other than an integer, and
the period of time for the m₁-times rotation of the longitudinal axis of the carrier is substantially equal to the period of time for the translational movement of the build-up burners from a burner-to-burner distance d.

2. The method according to claim 1, wherein
the deposition surface rotates about the longitudinal axis of the carrier, and
the period of time for the (m₂+(k/n))-times rotation of the deposition surface about the longitudinal axis of the carrier substantially corresponds to the period of time for the translational movement of the build-up burners from a burner-to-burner distance d, wherein m₂ is an integer from 1 to 100, preferably from 3 to 35, even more preferably from 5 to 25, k is a natural number less than n, and m₁=m₂+(k/n).

3. The method according to claim 1, wherein the translational movements of the build-up burners represent a reversing movement whose direction changes at inflection points,
wherein the axial position of the inflection points changes relative to the deposition surface
and the longitudinal axis.

4. The method according to claim 3, wherein the inflection points of the reversing movement change in each stroke.

5. The method according to claim 3, wherein the inflection points change in each stroke according to a fixedly predefined movement pattern.

6. The method according to claim 3, wherein the inflection points change by a statistically changed offset in each stroke.

7. The method according to claim 1, wherein the build-up burners perform a translational movement substantially parallel to the longitudinal axis of the rotating carrier by an amplitude of twice the burner-to-burner distance 2d, while the deposition surface substantially simultaneously performs a rotation of (m₂+(k/n)+y) revolutions, wherein m₂ is an integer from 1 to 100, preferably from 3 to 35, even more preferably from 5 to 25, k is a natural number less than n, m₁=m₂+(k/n) and y varies between −0.3 and0.3.

8. The method according to claim 1, wherein the rotation of the deposition surface and the variation of the inflection points are adapted such that the method results in a homogeneous soot build-up.

9. The method according to claim 1, wherein the movement profile of the build-up burners on the deposition surface is determined.

10. The method according to claim 9, wherein the movement profile of the build-up burners on the deposition surface is continuously monitored online by means of a processor during the deposition of the SiO₂ soot particles.

11. The method according to claim 10, wherein the processor identifies, from the movement profile of the build-up burners on the deposition surface, regions of the deposition surface
in which too few SiO₂ soot particles have been deposited for a homogeneous soot build-up.

12. The method according to claim 11, wherein the processor controls the rotation of the deposition surface about the longitudinal axis of the carrier and/or the inflection points of the reversing translational movement of the build-up burners such that a substantially homogeneous soot body is built up.

13. The method according to claim 11, wherein the longitudinal axis of the rotating carrier is oriented vertically or horizontally.

14. The method according to claim 11, wherein the longitudinal axis of the rotating carrier is oriented horizontally.

15. The method according to claim 1, wherein the frequencies of the translation of the build-up burners and the rotation of the deposition surface during each change of direction of the reversing movement of the build-up burners are adapted to the current diameter of the SiO₂ soot body.
